(19) United States
(12) Patent Application Publication
(10) Pub. No.: US 2022/0012462 A1
(43) Pub. Date: Jan. 13, 2022

(54) Systems and Methods for Remote Measurement using Artificial Intelligence

(71) Applicant: Drop In, Inc., Los Angeles, CA (US)

(72) Inventor: Joseph Shemesh, Los Angeles, CA (US)

(21) Appl. No.: 17/372,763

(22) Filed: Jul. 12, 2021

Related U.S. Application Data
(60) Provisional application No. 63/050,640, filed on Jul. 10, 2020.

(51) Int. Cl. G06K 9/00; G06T 7/50; G06T 7/73; B64C 39/02; G06T 7/62; G06T 11/20; G06F 3/0484; G06F 3/0488

(52) U.S. Cl. CPC G06K 9/0063; G06T 7/50; G06T 7/74; B64C 39/024; G06K 9/00671; B64C 2201/146; G06T 11/203; G06F 3/04842; G06F 3/04883; B64C 2201/127; G06T 7/62

(57) ABSTRACT

A system and method for remotely measuring a site or object with artificial intelligence. The system comprising: a computing device for remote measuring of at least one object within a captured image, the computing device comprising: a processor, a frontend service having a user interface, a database comprising one or more detected objects, an estimator controller, and a detector controller. The method comprising a step for obtaining a captured image with an identified detected object, a step for retrieving a reference image matched with the detected object and a set of dimensions associated with the reference image, a step for determining that at least one threshold has been met by the detected object, and a step for generating a depth map based off the captured image.

### CROSS-REFERENCE TO RELATED APPLICATIONS

This application claims priority to and the benefit of U.S. Provisional Patent Application No. 63/050,640, filed Jul. 10, 2020, the contents of which are hereby incorporated by reference herein for all purposes.

### TECHNICAL FIELD

Embodiments relate generally to remote measuring, and more particularly to remote measuring of an area or object using artificial intelligence.

### BACKGROUND

Remote inspection of an area or object may require accurate measurements of the area or object, such as accurate measurements of a damaged area or object (or objects) related to generation of an insurance claim. Capturing devices are often employed to select an object or area.

### SUMMARY

A system embodiment may include storing processor-executable process steps for remote measuring of an area or object with artificial intelligence (AI). Embodiments may relate to the generation of insurance claims. More specifically, the insured may wish to demonstrate value of an object or to report damage to an object. As such, the insured may use a computing device for processing an image or video, such as a mobile device. In some embodiments, an insurance adjuster may guide the insured and use the insured's mobile device as a proxy. In some embodiments, the insured may take a picture of an object associated with their property, and the computing device may execute steps to compare at least one reference object in the image with a reference image in a database of a known size to produce a size measurement of the at least one reference object in the image.

A method embodiment comprising a step for obtaining a captured image with an identified reference object, a step for retrieving a reference image matched with the reference object and a set of dimensions associated with the reference image, a step for determining that at least one threshold has been met by the reference object, and a step for generating a depth map based off the captured image.

In one embodiment, the system may include a user, at least one operator, and a computing device for remote measuring of at least one object within a captured image. The computing device may include a processor, a frontend service having a user interface, a database having at least one reference object, an estimator, and a detector.

In one embodiment, the frontend service transmits a picture link of the capture image to the detector and the estimator. The detector may detect at least one reference object within the captured image, and the estimator calculates an image depth map. The detector may then send position data of the at least one reference object to the frontend service, where the user selects a reference image from the user interface to be compared to the at least one reference object in the captured image. The estimator may validate that the at least one reference object is in the image depth map. The user may use a tool at the user interface to make an outline of the at least one reference object in the captured image and the detector may measure the area of the outline. The estimator may validate the position of the at least one reference object.

In some embodiments, the estimator may return a response to the frontend service as to whether or not the estimator was able to accurately validate the at least one reference object's coordinates to a threshold value of accuracy. In some embodiments, the estimator and the detector may work simultaneously. In some embodiments, the user may be guided remotely by the at least one operator. In some embodiments, the user may operate the computing device offline.

A system embodiment may include: a computing device for remote measuring of at least one detected object within a captured image, the computing device comprising; a processor in communication with an addressable memory; a frontend service having a user interface; an estimator controller; a detector controller; a database comprising one or more reference images, the database in communication with the computing device; where the frontend service may be configured to transmit a picture link of the captured image to the detector controller and the estimator controller; where the detector controller may be configured to detect at least one detected object within the captured image; where the estimator controller may be configured to calculate an image depth map; and where the detector controller transmits position data of the one or more detected objects in the captured image to the frontend service, where a user selects a reference object from the user interface to be compared with the at least one object in the captured image, and the estimator controller validates that the selected reference object may be in the image depth map.

In additional system embodiments, the estimator returns a response to the frontend service as to whether or not the estimator was able to accurately validate the at least one object's coordinates to a threshold value of accuracy. In additional system embodiments, the estimator and the detector execute operations simultaneously. In additional system embodiments, the user may be guided remotely by at least one operator. In additional system embodiments, the user may operate the computing device offline.

In additional system embodiments, the user may use a tool at the user interface to make an outline of the at least one object in the image. In additional system embodiments, the detector controller may be further configured to measure the area of the outline. In additional system embodiments, the estimator controller may be further configured to validate the position of the at least one object based on the measured area received from the detector controller.

A method embodiment may include: obtaining a captured image with an identified detected object; retrieving a reference image matched with the detected object and a set of dimensions associated with the reference image; determining that at least one threshold has been met by the detected object; and generating a depth map based off the captured image.

Additional method embodiments may include: identifying a detected object within the captured image. In additional method embodiments, the at least one threshold may be a minimum size threshold. In additional method embodiments, the detected object has a substantially polygonal shape. In additional method embodiments, the detected object may be substantially flat. In additional method embodiments, the captured image may be captured at a 90 degree angle.

In additional method embodiments, the detected object may be identified by extracting the detected object from the captured image and matching the detected object with a reference image stored in a database. Additional method embodiments may include: obtaining distance information from a depth sensor. Additional method embodiments may include: generating a depth map based off the distance information obtained from the depth sensor.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a system for remote measuring of an area or object with artificial intelligence (AI);

FIG. 2 depicts a workflow of the system of FIG. 1;

FIG. 3 depicts a legend of shape/object designations for a database of the workflow of FIG. 2;

FIG. 4 depicts a flow diagram of a first stage of the workflow of FIG. 2;

FIG. 5 depicts a flow diagram of a second stage of the workflow of FIG. 2;

FIG. 6 depicts a flow diagram of a third stage of the workflow of FIG. 2;

FIG. 7 is a flow chart of a guiding component with a first maximum distance threshold;

FIG. 8 is a flow chart of a guiding component with a second maximum distance threshold;

FIG. 9 is a flow chart of a method embodiment of the present embodiments;

FIG. 10 illustrates an example top-level functional block diagram of a computing device embodiment;

FIG. 11 shows a high-level block diagram and process of a computing system for implementing an embodiment of the system and process;

FIG. 12 shows a block diagram and process of an exemplary system in which an embodiment may be implemented; and

FIG. 13 depicts a cloud computing environment for implementing an embodiment of the system and process disclosed herein.

### DETAILED DESCRIPTION

The described technology concerns one or more methods, systems, apparatuses, and mediums storing processor-executable process steps for remote measuring of an area or object with artificial intelligence (AI). Embodiments may relate to the generation of insurance claims. More specifically, the insured may wish to demonstrate value of an object or to report damage to an object. As such, the insured may use a computing device for processing an image or video via a user equipment, such as a mobile device having a processor and addressable memory. In some embodiments, an insurance adjuster may guide the insured and use the insured's mobile device as a proxy. In some embodiments, the insured may take a picture of an object associated with their property, and the computing device may execute steps to compare at least one detected object in the captured image with a reference image in a database, the reference image either having a reference object or solely consisting of the reference object of a known size and dimensions. Therefore the system may be configured to produce a size measurement of the at least one detected object in the captured image. As described herein, a reference is a relationship between objects in which one object designates, or acts as a means by which to connect to or link to, another object. The first object in this relation is said to refer to the second object. That is, at least one detected object (the first object) is compared to a reference object (the second object) having the same characteristics and/or a relationship to each other.

Remote inspection of an area or object may require accurate measurements of the area or object. In one embodiment, capturing devices, such as stereo or stereophonic cameras of a device, may be employed to select an object or area. Generally speaking, stereophonic cameras may have two or more lenses with a separate image sensor or film frame for each lens. The two or more lenses may allow the camera to simulate human binocular vision; therefore, the camera provides the ability to capture three-dimensional images. Stereo cameras may be used for making stereo views and 3D pictures for movies, or for range imaging (e.g., the distance to points in a scene from a specific point, normally associated with some type of sensor device). Other embodiments may use a capture device having one lens and be configured to execute instructions on a processor for post processing of such captured images.

It may be desired for a user to inspect a remote area or object with a device and relay streaming images to a remote operator; however, this may require that the user device have a stereophonic camera and that the measurements be performed in real time. Additionally, the remote operator may not have any tools on the remote operator's computing device to select the measured area or object, and any such tools may be dependent on the streaming stereophonic camera. The stereophonic camera may feed or stream the image or video in real time to the remote user's device and to a computer network, such as the Internet. The disclosed embodiments provide a system and method for remote measurement using AI; thereby eliminating the requirement for having a special equipment type of camera, for example, having two or more lenses with a separate image sensor or film frame for each lens.

The techniques introduced below may be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

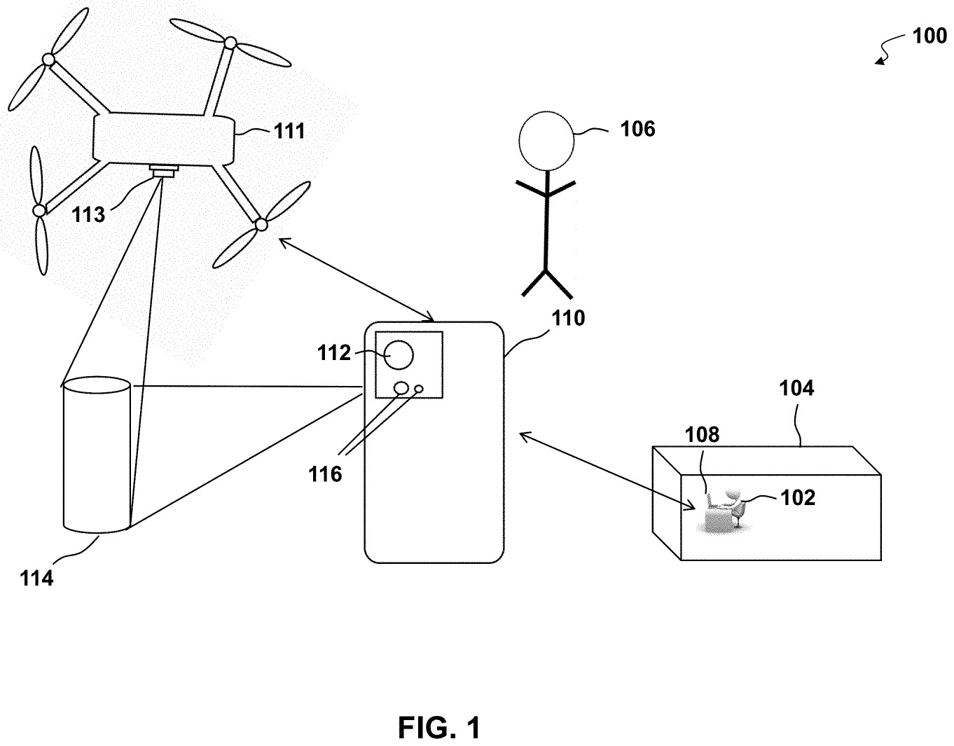

FIGS. 1-13 and the following discussion provide a brief, general description of a suitable computing environment in which aspects of the described technology may be implemented. Although not required, aspects of the technology may be described herein in the general context of computer-executable instructions, such as routines executed by a general- or special-purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the technology may be distributed over the Internet or over other networks (including wireless networks) on a propagated signal on a propagation medium (e.g., an electromagnetic wave, a sound wave, etc.) over a period of time. In some implementations, the data may be provided on any analog or digital network (e.g., packet-switched, circuit-switched, or other scheme).

The described technology may also be practiced in distributed computing environments where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Those skilled in the relevant art will recognize that portions of the described technology may reside on a server computer, while corresponding portions may reside on a client computer (e.g., PC, mobile computer, tablet, or smart phone). Data structures and transmission of data particular to aspects of the technology are also encompassed within the scope of the described technology.

With respect to FIG. 1, a system 100 for remote measuring of an area or object with an Artificial Intelligence (AI) system is illustrated. In one embodiment, the system 100 may include at least one operator 102 at a site 104, where the site 104 may be remote and at a large distance from the operator 102, the distance being at least out of visual range. The operator 102 may be in communication with a remote user 106 over a network, such as the Internet. More specifically, a computing device 108 of the operator 102 may be in communication with a device 110, for example, a user equipment, of the remote user 106. In one embodiment, the device 110 is a mobile device, such as a cell phone, tablet, or the like. In another embodiment, the device is an unmanned aerial vehicle (UAV) controlled by the remote user 106. In another embodiment, the unmanned aerial vehicle is controlled by the operator 102. In another embodiment, the operator 106 may be in communication with both the unmanned aerial vehicle 111 controlled and a mobile device 110 of the remote user at the same time. In another embodiment, the operator 106 may communicate with more than one remote user 106 and/or more than one unmanned aerial vehicle 111.

In one embodiment, the device 110 may have a capturing device, such as a camera 112, such as a streamer camera. In another embodiment, the unmanned aerial vehicle 111 may also have a camera 113, such as a streamer camera to perform the same functions as the camera 112. The camera 112 may be used to capture images or video of a remote site or object 114 for surveying of the remote site or object 114. In one embodiment, the camera 112 may be angled so that the video or image is captured at an angle close to 90 degrees. In another embodiment, the system may adjust for and correct the angle of capture with respect to a reference plane, such a parallel to the local plane in real-time or near real-time. The streaming content may be transmitted to the computing device 108. In another embodiment, the streaming content may be transmitted to and processed at the device 110.

In one embodiment, the computing device 108 may receive the streaming content of the remote site 114. The computing device 108 may execute a process with an AI system which may include at least a set of tools for selection of an area, such as the site or object 114 or a portion of the site or object 114. In one embodiment, the AI system may be configured to be used offline. The operator 102 may guide the camera 112 to add a reference object next to the measured area 114. In another embodiment, the computing device 108 may automatically detect the detected object and add said detected object. In one embodiment, the reference object provides scale to the site or object 114 being captured by the camera 112. In one embodiment, the operator 102 controls the camera 112 and captures a flat video file. In the disclosed embodiments, the AI system may be run on the device 110 or as previously discussed, on the computing device 108.

One example where the system is applicable is where the user 106 may be an insured client that wishes to demonstrate value of an object or to report damage to an object. As such, the insured user 106 may use the device 110 and may run the AI system offline at the device 110 for processing an image or video. In some embodiments, the insured user 106 may take a picture of an object associated with the insured user's property, and the device 110 may execute steps to compare at least one detected object in the captured image with a reference object contained in a set of reference images stored in the database the reference object having a known size to produce a size measurement of the at least one object in the image. The detected object in the captured image may in one example have a substantially polygonal shape. The reference images stored in the database may depict physical objects. The system may then compare the identified at least one detected object form the captured image with the set of reference objects contained in the reference images stored in the database and if the detected object matches with at least one reference image, the device may retrieve a set of dimensions associated with the reference image from the database. The captured image, the identified detected object, the reference image, and the associated set of dimensions may then be sent to another computing device for further processing, where in one example, the processing may be done offline. In another embodiment, the operator 102 may guide the insured user and use the insured user's computing device 110 as a proxy. In one embodiment, the operator is an insurance adjuster.

In one embodiment, if the detected object has a matching reference image in the database, the AI system may retrieve the set of dimensions associated with the matching reference image from the database. The AI system may then utilize the set of dimensions to measure the rest of the objects in the captured image. If there is an existing known reference object, such as power switch, light switch, picture frame, doorknob, etc., the AI system may automatically select the reference object and use the reference object as the measurement of the remote area or object 114 that was captured. In one embodiment, if none of the reference images in the database can be matched with the detected object, there are not any known objects, or the known reference object is not at the right angle with the measured area, the system may be configured to display a prompt and then the operator 102 may select the right reference image from a dropdown list, such as dropdown list at a user interface of the computing device 108. In another embodiment, the user 106 may select the reference image from a dropdown list, such as dropdown list at a user interface of the device 110 or the computing device 108. In one embodiment, if the system determines that the known reference object is not at the right angle with the measured area, the system may be configured to rotate the image entirely and/or the known reference object to align the image with the local plane and adjust to correct the reference object.

In one embodiment, if none of the reference images can be matched with the detected object, the remote operator 102 may add a new reference image into the database. The remote operator may do so by cropping the detected object from the captured image, entering a set of dimensions that is associated with the now assigned reference image and then storing both the set of dimensions and the reference image in the database. In another embodiment, the user may add a new reference image into the database in the same manner as previously described. The process of adding a new reference image may be to create a new object by selecting the object, naming the object, and adding the correct length and width of the object. In another embodiment, if there is a new object, the user 106 may create a new object by selecting the object, naming the object, and adding the correct length and width of the object. After introducing a new object to the AI system, the object may be saved as a known object and saved for future use. Once the reference object is set, the operator 102 may use a set of drawing tools of the AI system, such as a rectangular, circular or a free-hand drawing tool to outline the reference object. In another embodiment, once the reference object is set, the user 106 may use a set of drawing tools of the AI system at the device 110, such as a rectangular, circular or a free-hand drawing tool to outline the reference object.

In one embodiment, the AI system may provide a set of dimensions that is associated with a manually inputted image. The AI system may generate a mesh shape based off the captured image. The AI system may then measure the reference object based on the generated mesh shape. The measurements of the reference object may then be stored as a set of dimensions associated with the manually inputted image. The mesh is a representation of a larger geometric domain by smaller discrete cells. The mesh may be used by the AI system to compute solutions of partial differential equations and render computer graphics, and to analyze sizes of objects in the image. More specifically, the mesh may be comprised of pixels of a known size; therefore, the total number of pixels within the mesh will yield a size measurement of the object.

In one embodiment, the device 110 may have a depth sensor 116. The depth sensor 116 may include a laser and a receiver positioned by the camera 112. The laser may be directed at the object 114 and the receiver may detect the reflected light. Lidar may then be used to determine the distance based off the information received by the receiver. In another embodiment, the device 110 may have rotational sensors that determine the angle of the camera.

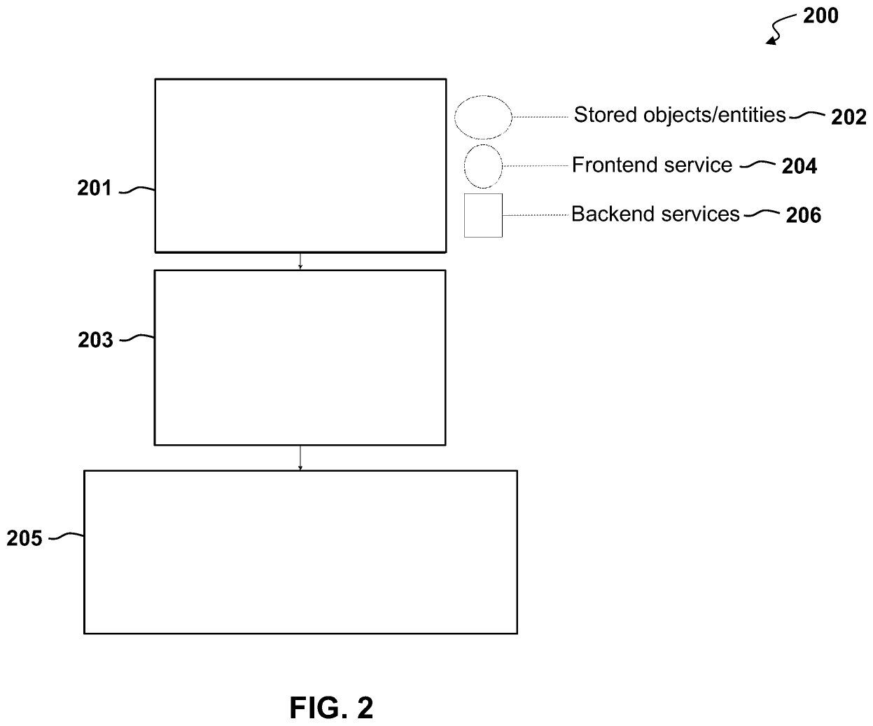

FIG. 2 shows a workflow 200 of an AI system, such as the AI system described above. In one embodiment, the workflow 200 may be divided into several, connected stages. Every stage may be backed by a list of queries for an estimator and a detector. In one embodiment, the workflow may include 3 stages: a preprocessing stage 201, a reference image selection stage 203, and a measuring stage 205. In one embodiment, every change in a previous stage of the workflow causes changes in the next stage or stages. For instance, if a new reference object is selected, all damaged and detected objects are to be recalculated.

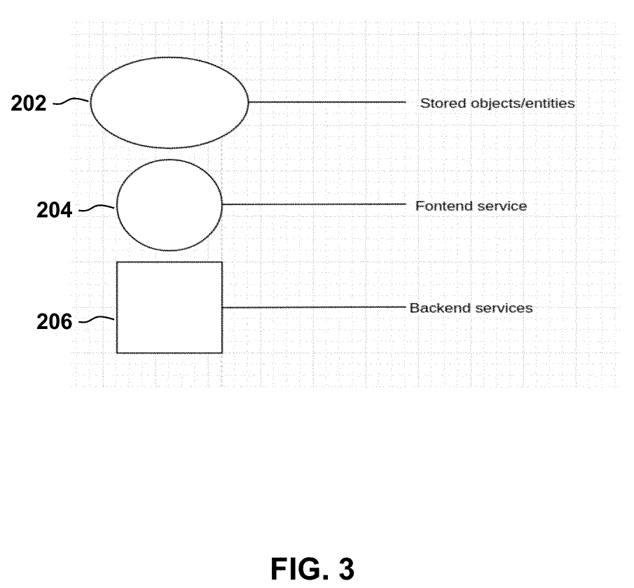

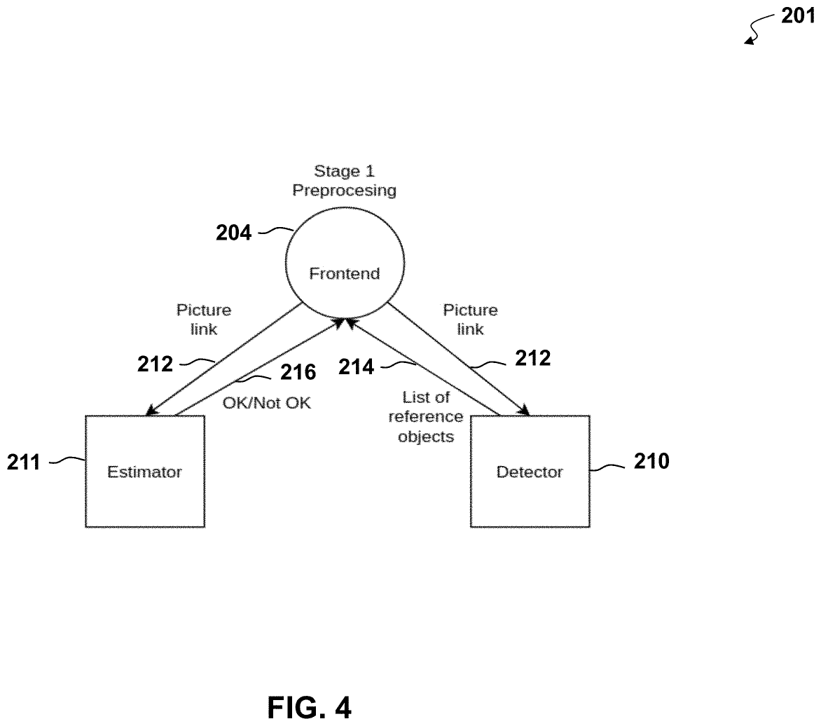

FIG. 2 also includes a legend of shape/object designations for a database system 202, a frontend service 204, and a backend service 206. The legend may be referred to for FIGS. 4-6 of this disclosure. With respect to FIG. 3, the legend of FIG. 2 is shown in detail and further described. In one embodiment, the database 202 may provide for storing reference images, a set of dimensions associated with the reference images, detected reference object coordinates, reference object scales, and depth maps. The frontend service 204 may provide for surveying and detection of a remote site or object, such as remote site or object 114 of FIG. 1, as well as generating a depth map based on the detected site or object. In one embodiment, a depth map, in 3-dimensional computer graphics and computer vision, may be an image or image channel that contains information relating to the distance of the surfaces of scene objects from a viewpoint. In one embodiment, a depth map may be related to and may be analogous to depth buffer, Z-buffer, Z-buffering and Z-depth. The “Z” in these latter terms may relate to a convention that the central axis of view of a camera is in the direction of the camera's Z axis, and not to the absolute Z axis of a scene.

The frontend service 204 may also provide for selection of the reference image, validation of the detected object and/or reference object, and retrieval of the corresponding scale. The backend service 206 may accept a download link and process an image, as well as other functions described below.

With respect to FIG. 4, a flow diagram of the first, preprocessing stage 201 of the measurement workflow 200 is shown. During the preprocessing stage 201, the frontend service 204 may transmit a picture link 212 associated with an image captured by the device 110 to both a detector 210 and an estimator 211. In one embodiment, the detector 210 and the estimator 211 may accept the picture link 212 as a download link and process the corresponding image. In one embodiment, the picture link 212 may be sent to the detector 210 and the estimator 211 at the same time, and the detector 210 and the estimator 211 may operate on the picture link 212 simultaneously. In one embodiment, a URL may be used as an ID for the picture link 212, where the ID may be a unique ID generated to be used for this purpose.

In one embodiment, the detector 210 may be trained to identify detected objects in a captured image. More specifically, an engine of the AI system may be trained with a data set of different known objects to use as a reference object from the database 202. In one embodiment, if an object is a known object, the detector 210 uses a reference object from the database 202. The database 202 may have a set of measurements associated with the reference object and the set of measurements may include data on the dimensions of the reference object. In another embodiment, the detector 210 uses a reference object from the image itself, which may correspond to a known reference object, such as a chair. In one embodiment, the estimator 211 may measure two objects at the same time with respect to a single reference object. In one embodiment, the detector 210 may process multiple images of the same object or multiple objects of the same type in the same image. The detector 210 may assign each image to have a corresponding reference object. The detector 210 may then combine the multiple images together to provide a better understanding of the object. The images may be combined to form a representation of physical space, such as a 3D view or a panoramic view. The detector 210 may in some embodiments, detect multiple reference objects to improve accuracy and increasing confidence in the measurements by ensuring the reference object has the right dimensions.

In one embodiment, the user 106 may select a reference image from the database 202 to be used to compare to the size of a detected object in the captured image for which the user 106 would like to make a realistic size measurement. For example, the user 106 may want to make a realistic size measurement of a light switch on a wall of a room within the picture link 212. The detector 210 may extract the light switch (detected object) from the image provided in the image link 212. The detector 210 may then match the extracted light switch with a reference object from the database 202. Once a match has been made, the database retrieves the reference object and the associated measurements. This process may analyze the image and retrieve an image of the light switch from the database 202, which has a known size, to use as a reference object to be compared to the light switch in the picture link 212. The system may gain, via the detector 210, a high-level understanding of the objects from digital images or videos, i.e., the retrieved images, by automating tasks that the human visual system is capable of.

In one embodiment, the detector 210 may use feature detectors such as corner detection, blob detection, and the difference of Gaussians, to find the detected object in the captured image. In one embodiment, the detector 210 may use image matching algorithms to detect and describe local features in images to achieve object recognition, robotic mapping and navigation, image stitching, 3D modeling, gesture recognition, video tracking, individual identification of object and match moving objects. In one embodiment, the user 106 may overwrite a set of dimensions associated with a reference image. One example of such object may be the light switch provided by the database 102. In one embodiment, if the user updates the size of the reference object beyond a threshold value, the computing device 110 may modify the reference object's dimensions. For example, the user (or users) may have at least one damaged light switch, each of which has a size of 2.5 inches by 4.5 inches. However, the database 102 may have a size of 2 inches by 4 inches for the area of the light switch reference object of the database 102. As such, the user will want to modify the size of the reference object in the database 102 to match that of the at least one damaged light switch. If the user is required to manually make this change more than a certain number of times, then the computing device triggers the database 102 to update the reference object's size to 2.5 inches by 4.5 inches in the database 102; therefore, the user no longer needs to make the modification in the future. As such, the system may learn over a period of time, based on the user's (or users') manually inputted dimensions, that the reference object's dimensions require updating in the database.

In one embodiment, the computing device 110 may modify the set of dimensions associated with a reference image after detecting multiple attempts to edit the set of dimensions. The computing device 110 may track each attempt to modify a set of dimensions and the values that are being entered with each attempt. If the computing device 110 determines that the number of attempts to edit the dimensions for a specific value has exceeded a threshold, the computing device may configure and update the set of dimensions to have that specific value as having been inputted a number of times. That is, in one example, the computing device 110, may not accept the first or second attempt at editing the dimensions and overwrite the previously stored values, but instead require the user set this value multiple times before accepting the value as a replacement for previously stored value.

In another embodiment, if the user updates the associated set of dimensions of the reference image beyond a threshold value, such as a maximum size, the computing device 110 may refuse to and deny input of the new set of dimensions into the database to modify the reference object's dimensions. For example, the database 102 may have a size of 2 inches by 4 inches for the area of the light switch reference image of the database 102; however, the user would like to manually override the dimensions to be 2.5 inches by 4.5 inches. If the user enters, perhaps erroneously, dimensions much larger than the associated set of dimensions, the computing device 110 may send a notification to the user that the manually inputted dimensions may be too large. Accordingly, erroneous modifications may be avoided based on use of previously acquired data and experience by the computing device via a natural intelligence by the computing device thereby demonstrating an ability to self-correct and maintain an accurate list of associated dimensions for the reference image. Therefore, the disclosed systems and methods for remote measurement may be configured to use AI in order to continuously update and store measurements for such reference images in the database.

The detector 210 may transmit at least one reference image 214 to the frontend service 204. In one embodiment, the processor of the computing device may select a reference image from a plurality of reference images 214 based on the estimator identifying the detected object being within the depth map. In one embodiment, the user 106 may select a reference image from a plurality of reference images 214 at the user interface. For example, the detector may transmit three light switch reference images to the frontend service 204. The user 106 may select one of the three reference images for comparison to the light switch in the image. In another embodiment, a light switch may not exist in the database 102 as a reference image, and the user 106 may add a new light switch image (and enter a size of the light switch) to the database 102 for future use, as will be described in detail below.

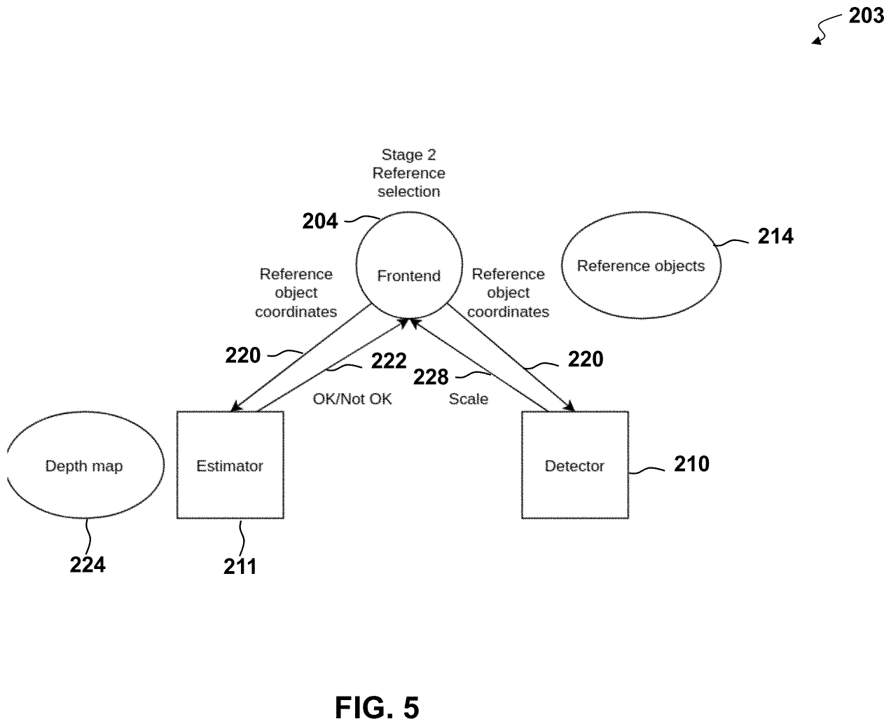

The estimator 211 may generate a depth map 224 (see FIG. 5) of the picture link (e.g., the detected site or object) 212, as described above where the depth map refers to a type of vertical distance and where vertical distance is the difference between two vertical positions. In one embodiment, the estimator may generate a depth map based on information received from the depth sensor 116. In one embodiment, the depth map may relate to the pixels extracted from the entire captured image. The depth map may provide the coordinate map for the user 106 at the user interface based on the pixels of the entire captured image. For example, the user 106 may hover over the captured image and select a spot in the captured image, such as the center of a detected, damaged object, and the depth map provides the position coordinates of the selected spot, e.g., the x and y coordinates.

Using the example above, the estimator 211 may generate a depth map of the picture link 212 and convert the picture link 212 into pixels of known size (e.g., a mesh). The depth map may reveal that, for example, the floor and the wall of the image are not the same surface. In one embodiment, the estimator 211 may return a success (OK) or failure (Not OK) response 216 to the frontend service 204 to indicate whether a depth calculation was successful based on the picture link 212, such as if whether or not the estimator 211 was able to generate a depth map that exceeds a threshold value of accuracy. In one embodiment, the threshold value of accuracy may correspond to a minimum number of pixels, where the number of pixels is proportional to the quality of the picture link 212. For example, if the number of pixels is low, then the threshold value of accuracy may be lower. In one embodiment, if the depth map is below the threshold value of accuracy, the user 106 may decide to not continue with the process. It is contemplated that in some embodiments, only the estimator 211 may be configured to return an error or failure signal to let the system know that the process cannot be completed with the current data.

The detector 210 and the estimator 211 may perform their respective operations simultaneously; therefore, the detector 210 does not rely on the analysis of the estimator 211 at this stage, and vice versa. For example, if the detector 210 is unable to determine a reference object, the frontend 204 may wait for the estimator 211 to provide a depth map. Additionally, the user 106 may add a reference object via the user interface of the computing device 110 if the detector 210 is unable to provide a reference object.

With respect to FIG. 5, the second, reference image selection stage 203 of the workflow 200 is shown. At the second stage 203, a reference image 218 may be selected from the database 202 to be validated and to retrieve the corresponding scale of the detected object 212. More specifically, the computing device may determine which of the objects in the captured image may be select as a reference object in the captured image, where the detected object 212 corresponds to a known reference image in the database 202. The reference image 218 may be a vector graphic, allowing the reference image 218 to be potentially re-sized for comparison without any loss in picture quality. The user 106 may center a cursor over the detected object in the captured image for which the user 106 would like to compare to the reference image to make a size measurement. The user 106 may use a set of drawing tools of the AI system, such as a rectangular, circular or a free-hand drawing tool to outline the detected object. The user 106 may then click on a central position of the detected object, and the associated positional coordinates 220 (e.g., x, y coordinates of the image), and the frontend 204 may transmit the coordinates 220 of the detected object to both the detector 210 and the estimator 211.

In one embodiment, if a detected object is unable to match with a reference image in the database, that is, the object is an unknown object (e.g., an object that is not in the database 102), the user 106 may add a new reference image associated with the unmatched detected object to the database 102. For example, if the unmatched detected object is a credit card, the user may add an image of a credit card to the database 102 and the user 106 may manually specify the size of the credit card (and provide a name for the object, such as “credit card”); therefore, the credit card image provided by the user may be used as a new reference image while the size is used for the set of dimensions. In one embodiment, the user may input a new set of dimensions by clicking on the detected object in the captured image and manually entering an approximate size. In one embodiment, changing the size of the image does not affect the selected x, y coordinates. In some embodiments, 3D measurements of objects may be done in real time using, for example, Stereophonic supported camera systems.

In one embodiment, the estimator 211 may validate that the reference object is within the generated depth map. The estimator 211 may return a success (OK) or failure (Not OK) response 222 to the frontend service 204 as to whether it is possible to use the reference object 212 with the transmitted reference object coordinates 220 as the reference. In one embodiment, a threshold may be used to determine if the returned measurement results make logical sense based on comparison with other objects. For example, the threshold could be a minimum size for a reference object. If the measurement is below the minimum size or threshold, then a failure response 222 may be transmitted. In one embodiment, this warning may be ignored by a user. The detector 210, in turn, may transmit a scale 228 to the frontend service 204. The corresponding scale 228 may be saved on the frontend service 204 for duplication. As described above, an operator may guide the camera to add a reference object next to the measured area, and the reference object provides scale to the site or object being captured by the camera.

In one embodiment, the captured image, the detected object, and the corresponding scale 228 are stored in a saved state by the user interface. The user interface may store the image, the detected object, and the corresponding scale to a saved state if the user interface has determined a condition has been met. In one embodiment, the condition is a pre-determined period of inactivity. In another embodiment, the condition is a period of time or the expiration of said period of time. After storing the information, the user interface may later prompt a user to determine whether the information should be continued to be stored or should the information be released.

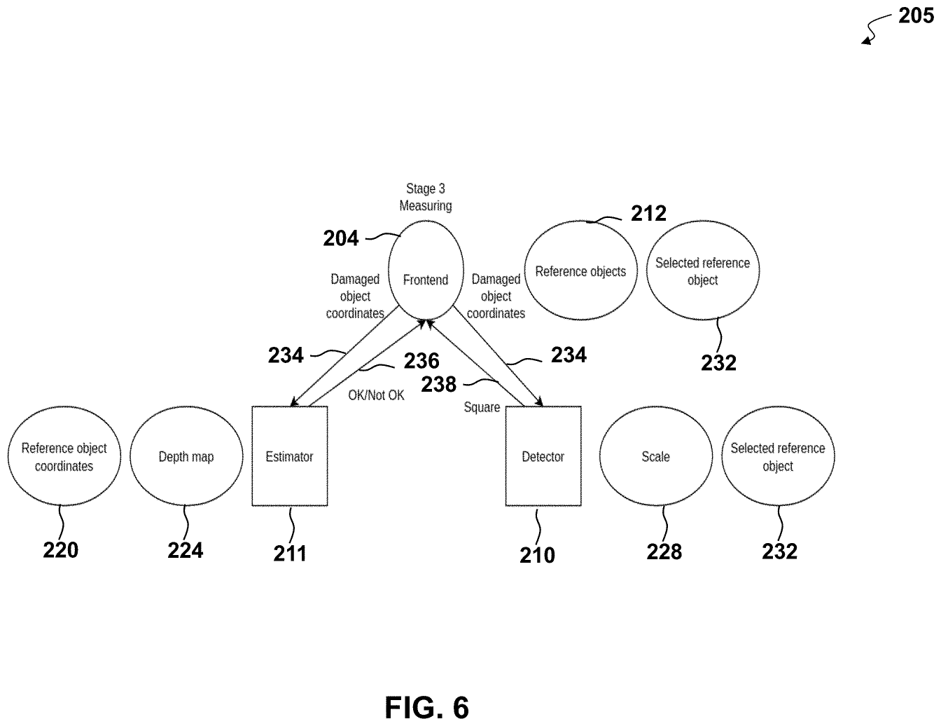

With respect to FIG. 6, the third, measuring stage 205 of the workflow 200 is shown. As described above, once the reference object is set, the user 106 or frontend operator may use a set of drawing tools of the AI system, such as a rectangular, circular or a free-hand drawing tool to outline, for example, a damaged object in an image. The outline may be selected by the user 106, and damaged object coordinates 234 (e.g., the x and y coordinates of the damaged object) may be transmitted to the estimator 211 and the detector 210 from the frontend service 204 in a similar vein as the reference object coordinates of FIG. 5. The detector 210 may compute the area of the selected outline. The estimator 211 may validate the damaged object's position and return a success (OK) or failure (Not OK) response 236 to the frontend service 204 as to whether or not the estimator 211 was able to accurately validate the damaged object's coordinates to a threshold value of accuracy. In one embodiment, the detector 210 and the estimator 211 may process more than one damaged area or object at the same time.

The estimator 211 may convert the area into pixels. The detector 210 may calculate the area of the outline. In one embodiment, if the outline is a known geometric shape, such as a rectangle, measurements 238 such as the height and width may be returned to the user 106 as well as the area (height multiplied by the width). If the known geometric shape is a circle, a radius may be returned to the user 106 as well as the area (pi times the radius squared), and so forth. In one embodiment, more than one object may be selected by the user 106 for area measurements of said objects. For example, a wall may have three different damaged objects on the wall in the image. The user 106 has the option to either measure any one of the three damaged objects on the wall or the user 106 may select all three damaged objects for measurement.

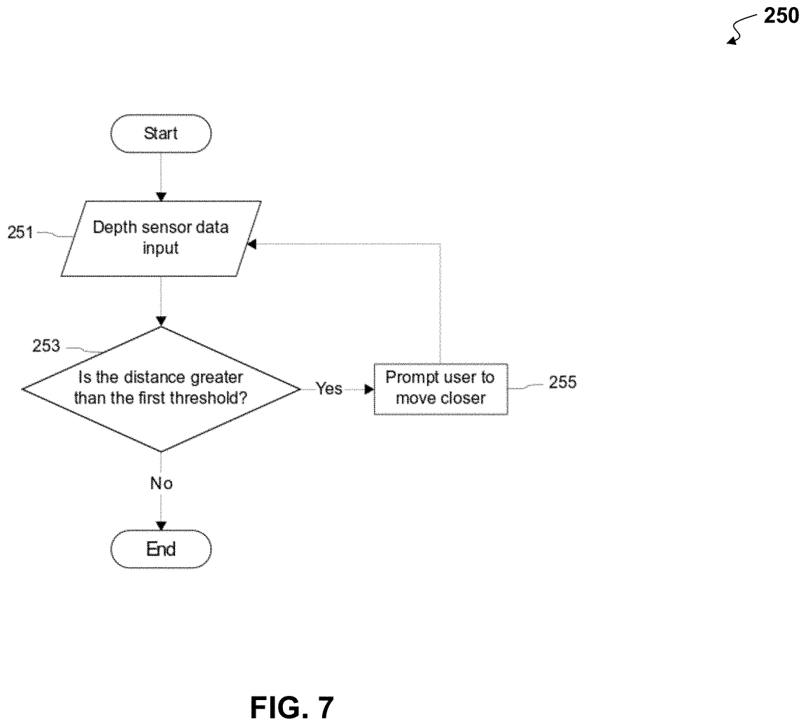

Referring to FIG. 7, in one embodiment, a guiding component 250 may guide a user to add the reference object next to the site or concerned object. The guiding component 250 may continuously receive distance information as part of depth sensor data input 251 from the depth sensor to determine how far away the camera is from the site or concerned object. The guiding component then may determine 253 if the distance between the camera and the site exceeds a first predetermined maximum distance threshold. If the distance between the camera and the site or the concerned object exceeds the first predetermined maximum distance threshold, the guiding component 250 may prompt 255 the user to move the camera closer to the site or concerned object.

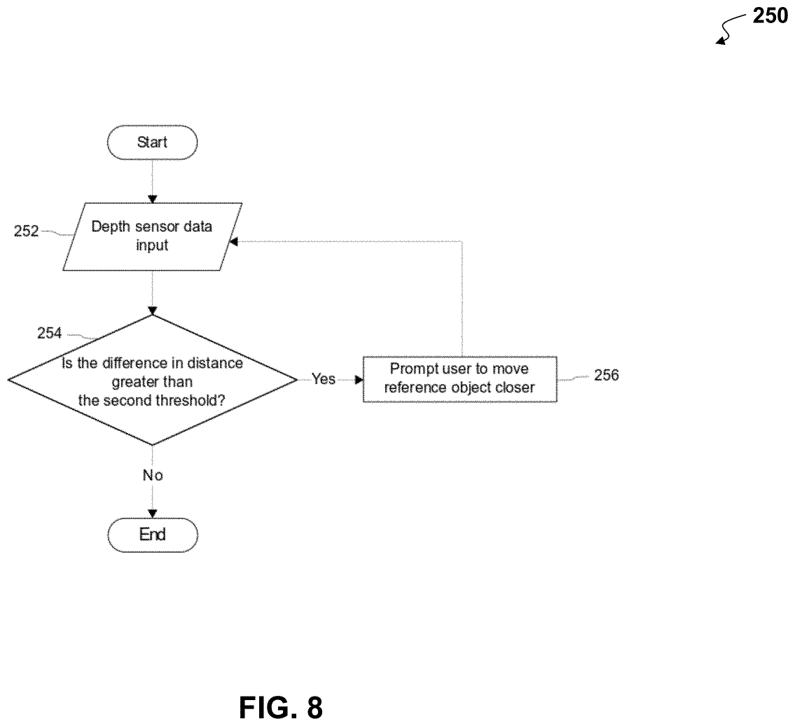

Now referring to FIG. 8, in one embodiment, the guiding component 250 may continuously receive 252 distance information from the depth sensor to determine how far the site or concerned object is from the camera and how far the reference object is from the camera. The guiding component then may determine 254 if the difference between the distance from the camera to the site or concerned object and the distance from the camera to the reference object exceeds a second predetermined maximum distance threshold. If the guiding component 250 determines that the difference between the two distances is greater than a second predetermined maximum distance threshold, the guiding component may prompt 256 the user to move the reference object closer to the site or concerned object.

The guiding component 250 may also determine that the camera is not properly aligned for taking a picture. The guiding component 250 may obtain the angle of the camera from the rotational sensors in the device and compare the angle with a predetermined angle threshold. If the angle of the camera meets or exceeds the angle threshold, the guiding component 250 may prompt the user to adjust their camera so that the angle threshold is no longer being met or exceeded.

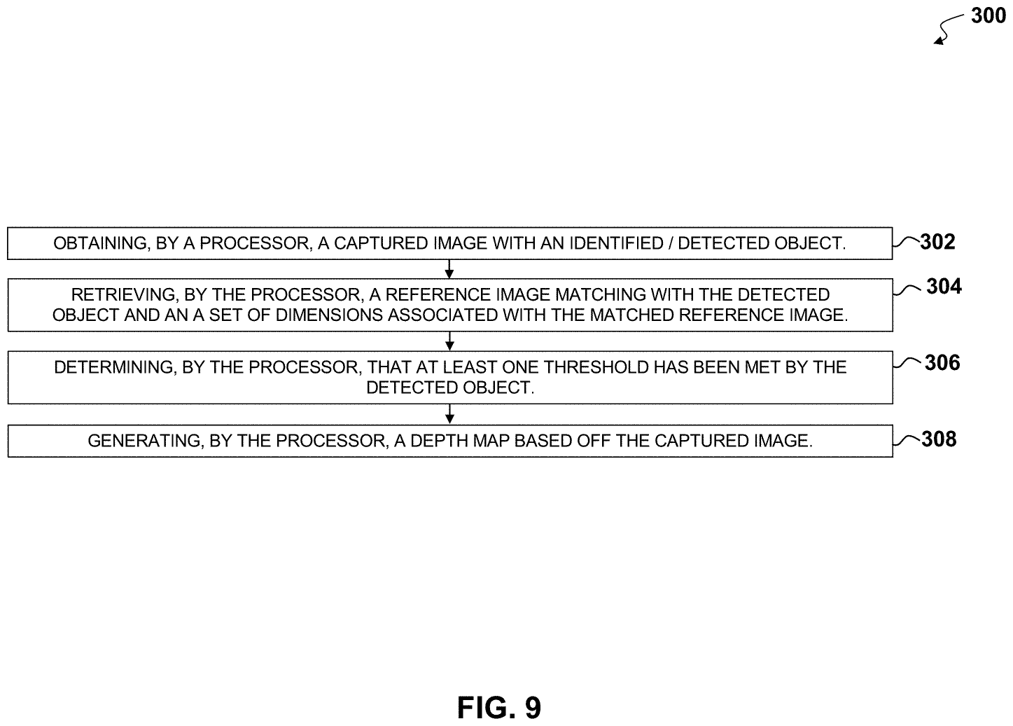

FIG. 9 is a flow chart of a method 300 for creating a depth map of an image. The method 300 may be executed on a processor having addressable memory. The method 300 may begin with a step 302 for obtaining a captured image with an identified and detected object. In one embodiment, the obtaining step 302 may be done by first extracting the detected object from the captured image. The detected object is then compared to a plurality of reference images stored in a database to find a matching reference image. The matching reference image may then be used to identify the detected object. In another embodiment, the obtaining step 302 may be done by prompting a user to manually input the captured image, locate the detected object in the captured image, and match the detected object to a reference image. The user may use a cropping tool to identify the detected object. The method 300 may then have a step for retrieving 304 the matched reference image and a set of dimensions associated with the matched reference image. In one embodiment, the matched reference image and the set of dimensions are retrieved from a database. The method 300 may then have a step 306 for determining whether at least one threshold has been met by the reference object. In one embodiment, the threshold may be a minimum size. In another embodiment, the threshold may be an accuracy threshold that is proportional to the amount of pixels in the image. If the threshold has not been met, an alert may be sent out indicating that the threshold has not been met. If the detected object has met the threshold, the method 300 may then have a step 308 for generating a depth map based on the captured image. In one embodiment, the generated depth map has pixels with corresponding depth levels.

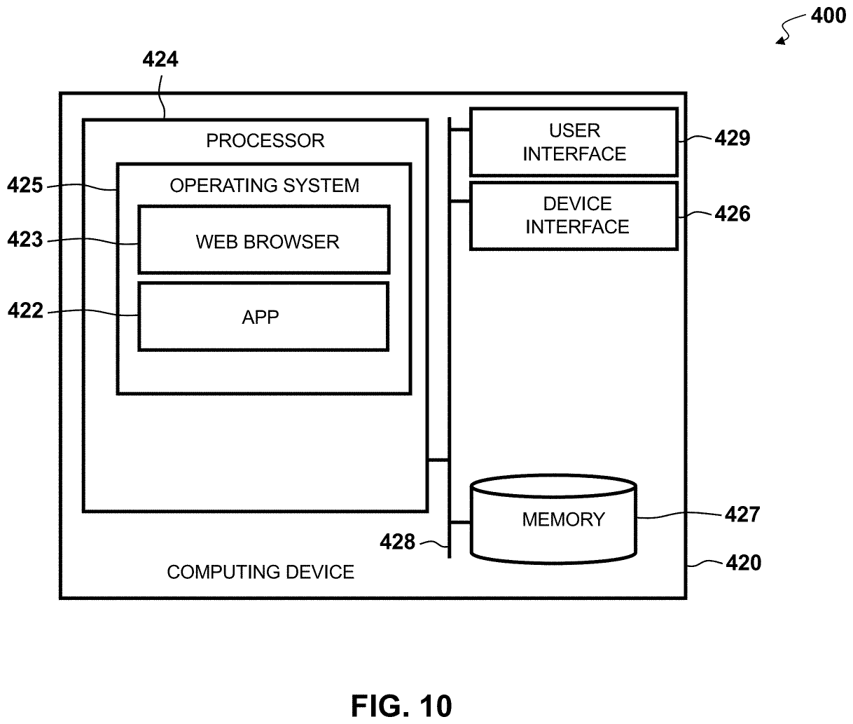

FIG. 10 illustrates an example of a top-level functional block diagram of a computing device embodiment 400. The example operating environment is shown as a computing device 420 comprising a processor 424, such as a central processing unit (CPU), addressable memory 427, an external device interface 426, e.g., an optional universal serial bus port and related processing, and/or an Ethernet port and related processing, and an optional user interface 429, e.g., an array of status lights and one or more toggle switches, and/or a display, and/or a keyboard and/or a pointer-mouse system and/or a touch screen. Optionally, the addressable memory may include any type of computer-readable media that can store data accessible by the computing device 420, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a LAN, WAN, or the Internet. These elements may be in communication with one another via a data bus 428. In some embodiments, via an operating system 425 such as one supporting a web browser 423 and applications 422, the processor 424 may be configured to execute steps of a process establishing a communication channel and processing according to the embodiments described above.

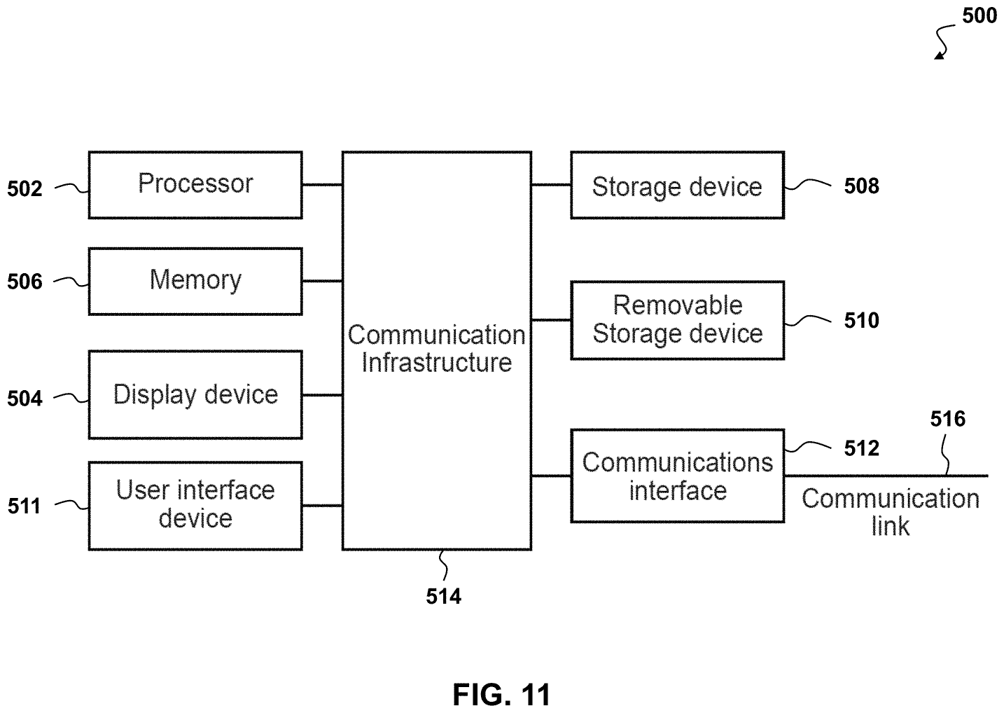

FIG. 11 is a high-level block diagram 500 showing a computing system comprising a computer system useful for implementing an embodiment of the system and process, disclosed herein. Embodiments of the system may be implemented in different computing environments. The computer system includes one or more processors 502, and can further include an electronic display device 504 (e.g., for displaying graphics, text, and other data), a main memory 506 (e.g., random access memory (RAM)), storage device 508, a removable storage device 510 (e.g., removable storage drive, a removable memory module, a magnetic tape drive, an optical disk drive, a computer readable medium having stored therein computer software and/or data), user interface device 511 (e.g., keyboard, touch screen, keypad, pointing device), and a communication interface 512 (e.g., modem, a network interface (such as an Ethernet card), a communications port, or a PCMCIA slot and card). The communication interface 512 allows software and data to be transferred between the computer system and external devices. The system further includes a communications infrastructure 514 (e.g., a communications bus, cross-over bar, or network) to which the aforementioned devices/modules are connected as shown.

Information transferred via communications interface 514 may be in the form of signals such as electronic, electromagnetic, optical, or other signals capable of being received by communications interface 514, via a communication link 516 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 512. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

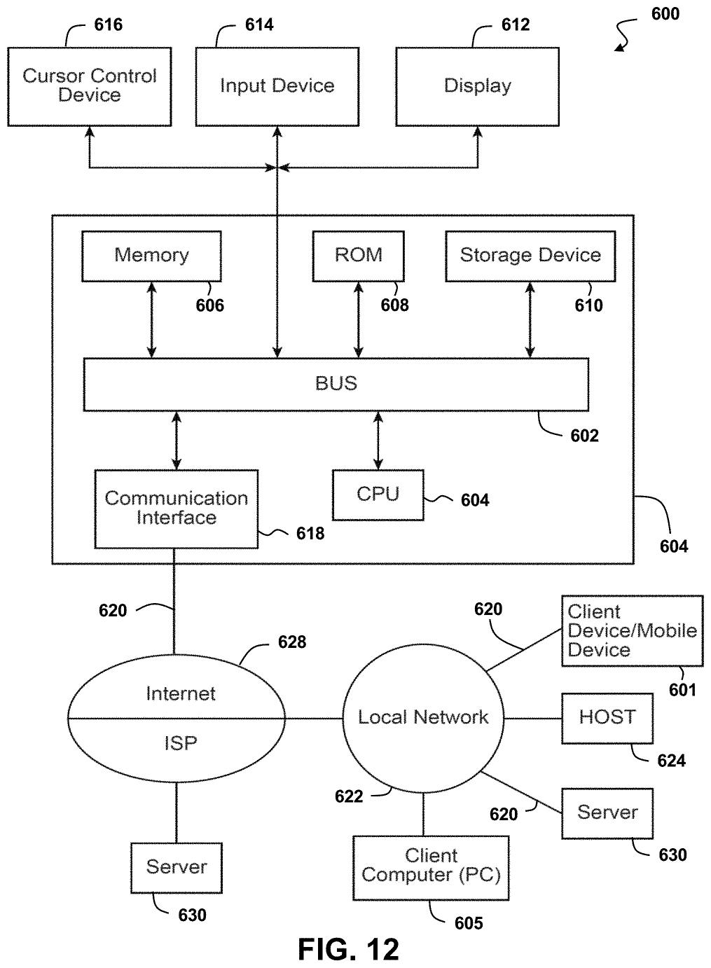

FIG. 12 shows a block diagram of an example system 600 in which an embodiment may be implemented. The system 600 includes one or more client devices 601 such as consumer electronics devices, connected to one or more server computing systems 630. A server 630 includes a bus 602 or other communication mechanism for communicating information, and a processor (CPU) 604 coupled with the bus 602 for processing information. The server 630 also includes a main memory 606, such as a random access memory (RAM) or other dynamic storage device, coupled to the bus 602 for storing information and instructions to be executed by the processor 604. The main memory 606 also may be used for storing temporary variables or other intermediate information during execution or instructions to be executed by the processor 604. The server computer system 630 further includes a read only memory (ROM) 608 or other static storage device coupled to the bus 602 for storing static information and instructions for the processor 604. A storage device 610, such as a magnetic disk or optical disk, is provided and coupled to the bus 602 for storing information and instructions. The bus 602 may contain, for example, thirty-two address lines for addressing video memory or main memory 606. The bus 602 can also include, for example, a 32-bit data bus for transferring data between and among the components, such as the CPU 604, the main memory 606, video memory and the storage 610. Alternatively, multiplex data/address lines may be used instead of separate data and address lines.

The server 630 may be coupled via the bus 602 to a display 612 for displaying information to a computer user. An input device 614, including alphanumeric and other keys, is coupled to the bus 602 for communicating information and command selections to the processor 604. Another type or user input device comprises cursor control 616, such as a mouse, a trackball, or cursor direction keys for communicating direction information and command selections to the processor 604 and for controlling cursor movement on the display 612.

According to one embodiment, the functions are performed by the processor 604 executing one or more sequences of one or more instructions contained in the main memory 606. Such instructions may be read into the main memory 606 from another computer-readable medium, such as the storage device 610. Execution of the sequences of instructions contained in the main memory 606 causes the processor 604 to perform the process steps described herein. One or more processors in a multi-processing arrangement may also be employed to execute the sequences of instructions contained in the main memory 606. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 604 for execution. Such a medium may take many forms, including but not limited to, non-volatile media, volatile media, and transmission media. Non-volatile media includes, for example, optical or magnetic disks, such as the storage device 610. Volatile media includes dynamic memory, such as the main memory 606. Transmission media includes coaxial cables, copper wire and fiber optics, including the wires that comprise the bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 604 for execution. For example, the instructions may initially be carried on a magnetic disk of a remote computer. The remote computer can load the instructions into its dynamic memory and send the instructions over a telephone line using a modem. A modem local to the server 630 can receive the data on the telephone line and use an infrared transmitter to convert the data to an infrared signal. An infrared detector coupled to the bus 602 can receive the data carried in the infrared signal and place the data on the bus 602. The bus 602 carries the data to the main memory 606, from which the processor 604 retrieves and executes the instructions. The instructions received from the main memory 606 may optionally be stored on the storage device 610 either before or after execution by the processor 604.

The server 630 also includes a communication interface 618 coupled to the bus 602. The communication interface 618 provides a two-way data communication coupling to a network link 620 that is connected to the world wide packet data communication network now commonly referred to as the Internet 628. The Internet 628 uses electrical, electromagnetic or optical signals that carry digital data streams. The signals through the various networks and the signals on the network link 620 and through the communication interface 618, which carry the digital data to and from the server 630, are exemplary forms or carrier waves transporting the information.

In another embodiment of the server 630, interface 618 is connected to a network 622 via a communication link 620. For example, the communication interface 618 may be an integrated services digital network (ISDN) card or a modem to provide a data communication connection to a corresponding type of telephone line, which can comprise part of the network link 620. As another example, the communication interface 618 may be a local area network (LAN) card to provide a data communication connection to a compatible LAN. Wireless links may also be implemented. In any such implementation, the communication interface 618 sends and receives electrical electromagnetic or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP). The ISP in turn provides data communication services through the Internet 628. The local network 622 and the Internet 628 both use electrical, electromagnetic or optical signals that carry digital data streams. The signals through the various networks and the signals on the network link 620 and through the communication interface 618, which carry the digital data to and from the server 630, are exemplary forms or carrier waves transporting the information.

The server 630 can send/receive messages and data, including e-mail, program code, through the network, the network link 620 and the communication interface 618. Further, the communication interface 618 can comprise a USB/Tuner and the network link 620 may be an antenna or cable for connecting the server 630 to a cable provider, satellite provider or other terrestrial transmission system for receiving messages, data and program code from another source.

The example versions of the embodiments described herein may be implemented as logical operations in a distributed processing system such as the system 600 including the servers 630. The logical operations of the embodiments may be implemented as a sequence of steps executing in the server 630, and as interconnected machine modules within the system 600. The implementation is a matter of choice and can depend on performance of the system 600 implementing the embodiments. As such, the logical operations constituting said example versions of the embodiments are referred to for e.g., as operations, steps or modules.

Similar to a server 630 described above, a client device 601 can include a processor, memory, storage device, display, input device and communication interface (e.g., e-mail interface) for connecting the client device to the Internet 628, the ISP, or LAN 622, for communication with the servers 630.

The system 600 can further include computers (e.g., personal computers, computing nodes) 605 operating in the same manner as client devices 601, where a user can utilize one or more computers 605 to manage data in the server 630.

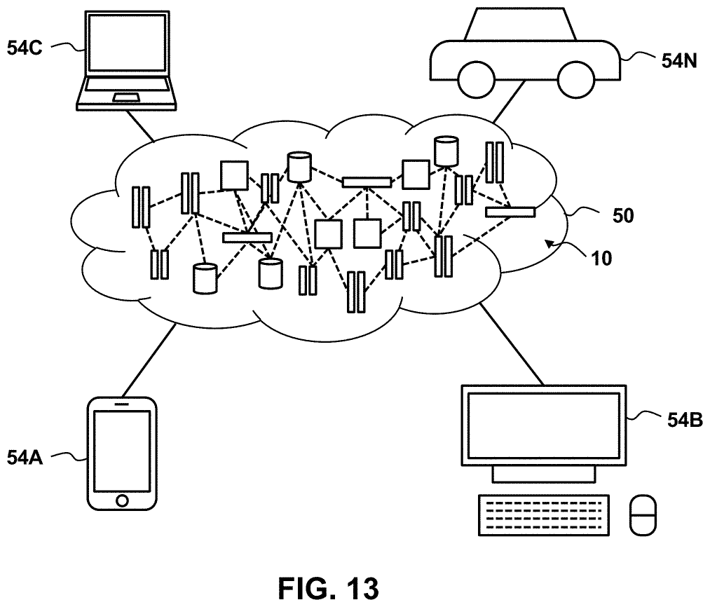

Referring now to FIG. 13, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 13 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a computing device for remote measuring of at least one detected object within a captured image, the computing device comprising;
a processor in communication with an addressable memory;
a frontend service having a user interface;
an estimator controller;
a detector controller;
a database comprising one or more reference images, the database in communication with the computing device;
wherein the frontend service is configured to transmit a picture link of the captured image to the detector controller and the estimator controller;
wherein the detector controller is configured to detect at least one detected object within the captured image;
wherein the estimator controller is configured to calculate an image depth map; and
wherein the detector controller transmits position data of the one or more detected objects in the captured image to the frontend service, wherein a user selects a reference object from the user interface to be compared with the at least one object in the captured image, and the estimator controller validates that the selected reference object is in the image depth map.

2. The system of claim 1, wherein the estimator returns a response to the frontend service as to whether or not the estimator was able to accurately validate the at least one object's coordinates to a threshold value of accuracy.

3. The system of claim 1, wherein the estimator and the detector execute operations simultaneously.

4. The system of claim 1, wherein the user may be guided remotely by at least one operator.

5. The system of claim 1, wherein the user may operate the computing device offline.

6. The system of claim 1, wherein the user may use a tool at the user interface to make an outline of the at least one object in the image.

7. The system of claim 6, wherein the detector controller is further configured to measure the area of the outline.

8. The system of claim 7, wherein the estimator controller is further configured to validate the position of the at least one object based on the measured area received from the detector controller.

9. A method comprising:
obtaining a captured image with an identified detected object;
retrieving a reference image matched with the detected object and a set of dimensions associated with the reference image;
determining that at least one threshold has been met by the detected object; and
generating a depth map based off the captured image.

10. The method of claim 9, wherein, the method further comprises:
identifying a detected object within the captured image.

11. The method of claim 9, wherein the at least one threshold is a minimum size threshold.

12. The method of claim 9, wherein the detected object has a substantially polygonal shape.

13. The method of claim 9, wherein the detected object is substantially flat.

14. The method of claim 9, wherein the captured image is captured at a 90 degree angle.

15. The method of claim 9, wherein the detected object is identified by extracting the detected object from the captured image and matching the detected object with a reference image stored in a database.

16. The method of claim 9, further comprising:
obtaining distance information from a depth sensor.

17. The method of claim 16, further comprising:
generating a depth map based off the distance information obtained from the depth sensor.
